(19) United States
(12) Patent Application Publication
(10) Pub. No.: US 2006/0095593 A1
(43) Pub. Date: May 4, 2006

(54) Parallel processing mechanism for multi-processor systems

(75) Inventor: Uwe Kranich, Kirchheim (DE)

Correspondence Address: MEYERTONS, HOOD, KIVLIN, KOWERT & GOETZEL, P.C., P.O. BOX 398, AUSTIN, TX, 78767-0398, US

(73) Assignee: Advanced Micro Devices, Inc.

(21) Appl. No.: 11/061,427

(22) Filed: Feb. 18, 2005

(30) Foreign Application Priority Data
Oct. 29, 2004 (DE) 10 2004 052 576.5

(51) Int. Cl. G06F 15/00

(52) U.S. Cl. 710/4

(57) ABSTRACT

A multi-processor computing device is provided that has at least two processing subsystems which each comprise a processor unit and at least one further component. In each processing subsystem, the processor unit is connected to the further component via a first link, and can be connected to at least one processor unit of another processing subsystem via a second link. The first and second links are physically decoupled, and the processing subsystems can simultaneously send data over the first and second links. There are further provided corresponding processing subsystems and multi-processor computing methods.

### BACKGROUND OF THE INVENTION

1. Field of the Invention

The invention generally relates to multi-processor computing devices and corresponding methods, and in particular to a technique for implementing parallel processing mechanisms.

2. Description of the Related Art

Multi-processor systems are generally used to increase the computing capabilities by building systems which have more than just one processor to perform the central processing tasks. Two structurally different concepts are known: SMP (Symmetrical Multi-Processing) and MPP (Massive Parallel Processing).

SMP systems have multiple identical processors that share the memory and make use of a global address space. Communication between the processors is done using a shared parallel bus. Usually, the parallelization of the applications is done by the operating system by assigning the different tasks to the various processors. However, SMP systems suffer from low scalability since the number of processors is limited by the capacity of the shared bus.

FIG. 1 illustrates a UMA (Unified Memory Access) multi-processor structure which is a specific example of conventional SMP systems. In the architecture of FIG. 1, the multiple processor modules 100, 110, 120 consist of the actual processors each having an on-chip L1 cache, and an L2 cache. In SMP capable processors, the L2 caches are either frontside caches or backside caches integrated into the CPU (Central Processing Unit) or arranged externally as backside caches. Thus, the shared bus is a processor bus 130 which may be extended to provide some further functionality, e.g., to support split bus transactions.

As mentioned above, the scalability of systems like those shown in FIG. 1 are limited by the shared bus 130 to a maximum of usually four to eight processors. Crossbar switch technology may be used to increase the number of processors. This technique is quite complex, however, and leads to increased development and manufacturing costs.

Other SMP techniques to increase the scalability include the NUMA (Non-Uniform Memory Access) and the COMA (Cache Only Memory Architecture) architectures. However, these techniques introduce undesired asymmetry to the I/O and graphics systems.

MPP systems have a plurality of computer nodes which are processor memory groups which are independent from each other and which each run an operating system. There is no common address space so that communication between the nodes requires message buses or even networks. MPP systems are easily scalable but are difficult to program since each application program has to deal with the parallel processing by itself.

Thus, conventional techniques are either limited with respect to the scalability, or are difficult to implement. The lack of flexibility in implementing the parallel processing mechanisms often results from the fact that conventional systems have the parallelization mechanism hardwired into the system.

### SUMMARY OF THE INVENTION

An improved multi-processing technique is provided that may allow for high performance parallel processing in easily scalable structures implementing flexible parallelization mechanisms.

In one embodiment, there is provided a multi-processor computing device that comprises at least two processing subsystems. Each processing subsystem comprises a processor unit and at least one further component. In each one of the at least two processing subsystems, the processor unit is connected to the at least one further component via at least one first link. Further, the processor unit in each one of the at least two processing subunits is adapted to be connected to at least one processor unit of another one of the at least two processing subsystems via at least one second link. The at least one first link and the at least one second link are physically decoupled. The at least two processing subsystems are capable of simultaneously sending data over the at least one first link and the at least one second link.

According to another embodiment, a processing subsystem for use in a multi-processor computing device is provided. The processing subsystem comprises a processor unit and at least one further component. The processor unit is connected to the at least one further component via at least one first link. The processor unit is further adapted to be connected to at least one processor unit of another processing subsystem via at least one second link. The at least one first link and the at least one second link are physically decoupled. The processing subsystem is capable of simultaneously sending data over the at least one first link and the at least one second link.

In a further embodiment, there is provided a multi-processor computing method. The multi-processor computing method comprises operating a first and a second processing subsystem of a multi-processor computing device. The first and second processing subsystems each comprise a processor unit and at least one further component. Operating the first and second processing subunits comprises simultaneously sending data over at least one first link between the processor unit and a respective further component of one of the first and second processing subsystems, and at least one second link between the processor units of the first and second processing subsystems. The at least one first link and the at least one second link are physically decoupled.

In still a further embodiment, a computer-readable storage medium stores instructions that, when executed on a multi-processor computing device that has at least two processing subsystems which each comprise a processor unit and at least one further component, cause the multi-processor computing device to simultaneously send data over at least one first link between the processor unit and a respective further component of one of the processing subsystems, and at least one second link between the processor units of the processing subsystems. The at least one first link and the at least one second link are physically decoupled.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1 schematically illustrates a conventional UMA multi-processor structure;

FIG. 2 is a block diagram illustrating a processing subsystem and its components according to an embodiment;

FIG. 3 is a block diagram illustrating a graphics subsystem and its components according to an embodiment;

FIG. 4 illustrates a multi-processor computing device according to an embodiment;

FIG. 5 illustrates how a multi-processor computing device according to an embodiment can be operated;

FIG. 6 is a block diagram illustrating a multi-processor computing device according to another embodiment;

FIG. 7 illustrates a multi-processor computing device according to yet another embodiment;

FIG. 8a illustrates a frame horizontally split into frame regions according to an embodiment;

FIG. 8b illustrates a frame split into frame regions according to another embodiment;

FIG. 9 is a flow chart illustrating a process of operating the multi-processor computing device of FIG. 7 according to an embodiment;

FIG. 10 is a block diagram illustrating a multi-processor computing device according to still a further embodiment;

FIG. 11 is a flow chart illustrating the process of operating the multi-processor computing device of FIG. 10 according to an embodiment; and

FIG. 12 is a block diagram illustrating a multi-processor computing device according to still a further embodiment.

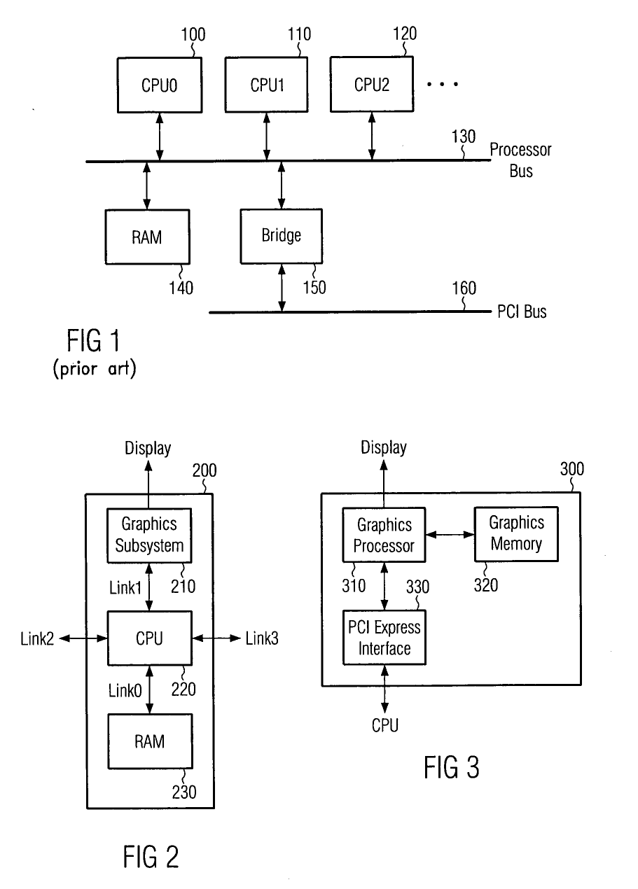

### DETAILED DESCRIPTION OF THE INVENTION

The illustrative embodiments of the present invention will be described with reference to the figure drawings wherein like elements and structures are indicated by like reference numbers.

As will be described in more detail below, the embodiments make use of processing subsystems that have a link structure which makes it possible to easily scale the system to increase the degree of parallelization in a flexible manner.

Referring to FIG. 2, an embodiment of a processing subsystem 200 is shown. The processing subsystem 200 of FIG. 2 comprises a central processing unit 220, a graphics subsystem 210, and a memory unit 230. The processor unit 220 is connected to the graphics subsystem 210 as well as to the memory unit 230, and has two further links which may be used to connect to other processing subsystems.

Thus, the arrangement of FIG. 2 has four links which are completely decoupled from each other and can operate in parallel. That is, the processing subsystem 200 has a dedicated link for each independent function: Link0 between the processor unit 220 and the memory unit 230, Link1 between the processor unit 220 and the graphics subsystem 210, Link2 between the processor unit 220 and a processor unit of a second processing subsystem, and Link3 between the processor unit 220 and a processor unit of a third processing subsystem.

Having dedicated links for each function allows these functions to use their links in a deterministic way so that no transfer is interrupted by other functions and each link has its full dedicated bandwidth without the need to share the bandwidth with other functions. This enables the processing subsystem 200 to perform highly concurrent transfers, and in addition makes the system highly scalable simply by adding further processing subsystems to a multi-processor computing device.

One or more of the links shown in FIG. 2 use ultra high speed technology such as HyperTransport™ compliant technology in an embodiment.

It is noted that the arrangement of FIG. 2 may be modified in further embodiments. For instance, processing subsystems may be implemented that have only one internal link and/or only one link to another processing subsystem. Further, processing subsystems may exist in further embodiments that comprise, in addition to the processor unit 220, only one further component 210, 230. These further components may be functional units other than a graphics subsystem or a memory (for instance peripheral driver hardware, audio control hardware, etc.). Further, the number of graphics subsystems 210 in the processing subsystem of other embodiments may be different from one. For instance, there may be no graphics subsystem 210 in the processing subsystem 200, or two or more.

Referring now to FIG. 3, a graphics subsystem 300 is depicted according to an embodiment, that may be used as component 210 in FIG. 2. As may be seen from FIG. 3, the graphics subsystem 300 of FIG. 3 comprises a graphics processor 310, an attached graphics memory 320, and a PCI (Peripheral Component Interconnect) Express bus interface 330. The graphics processor 310 can be connected to a monitor device to display the graphics.

The graphics subsystem 300 performs the necessary graphic operations. Various functionality modifications and implementations are possible. For instance, the graphics subsystem can be a standard graphics adapter card, a special chip which is directly coupled to the CPU, an external graphics subsystem, or it may be integrated on the CPU. Further, the connection to the CPU link may be different in the various embodiments. For instance, the CPU link may interface directly with the graphics subsystem, or it may require a bridge system.

In the embodiment of FIG. 3, the graphics subsystem 300 may be a PCI Express based off-the-shelf graphics adapter card having a direct connection to the CPU.

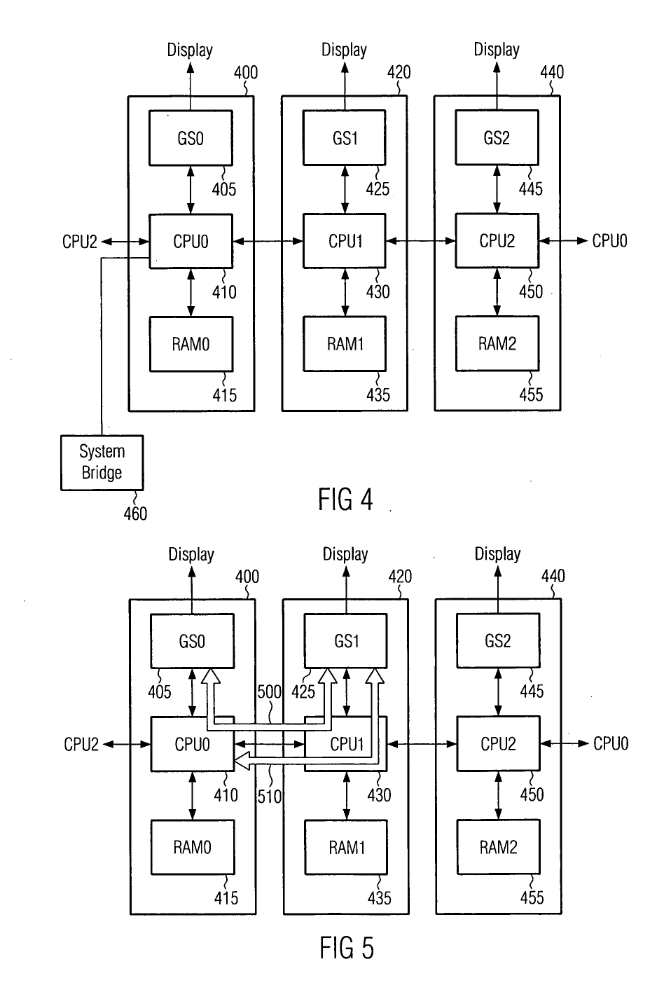

While not limited to the embodiments of FIGS. 2 and 3, a multi-processor computing device according to an embodiment may be built as shown in FIG. 4. In the arrangement of FIG. 4, three processing subsystems 400, 420, 440 are shown to be interconnected by CPU links. The processor units 410, 430, 450 of the processing subsystems 400, 420, 440 of the present embodiment are connected in a circular configuration, since the last processor unit 450 is connected to the first one.

It is to be noted that other embodiments may differ from the arrangement of FIG. 4 in the number of processor units 410, 430, 450 and/or graphics subsystems 405, 425, 445. This would then also modify the interconnection topology between the processor units 410, 430, 450, but the principal use of processing subsystems and their internal structure remains substantially identical.

Similarly, the type of internal links between the processor units 410, 430, 450 and the graphics subsystems 405, 425, 445 may vary in other embodiments. Examples of such embodiments will be described in more detail below.

As shown in FIG. 4, one or more of the processing subsystems can be connected to other system components to provide an interface to disks, networks, etc. In the example of FIG. 4, it is the processing subsystem 400 which is connected to a system bridge 460. The bridge 460 can be connected to various components in the system. It is noted that in other embodiments there may be no bridge at all, or more than one bridge connected to one or more of the processing subsystems 400, 420, 440.

Referring now to FIG. 5, a similar arrangement is shown to discuss possible functionalities of the embodiments. While not limited to this implementation, the sample arrangement of FIG. 5 has three processing subsystems 400, 420, 440 each having a processor unit 410, 430, 450, a memory unit 415, 435, 455, and a graphics subsystem 405, 425, 445 which may be an off-the-shelf PCI Express based graphics adaptor as shown in FIG. 3. All links are HyperTransport™ compliant in the present embodiment, and the processor units 410, 430, 450 are directly connected to the respective graphics subsystems 400, 420, 440.

In the embodiment, each component 405, 410, 415, 425, 430, 435, 445, 450, 455 of each processing subsystem 400, 420, 440 can communicate with any other component of its own processing subsystem 400, 420, 440 or any other processing subsystem 400, 420, 440. For instance, the processor unit 410 of the processing subsystem 400 may communicate with the graphics subsystem 425 of processing subsystem 420 by forming a data path 510 which includes the processor unit 430 of the processing subsystem 420. The processor unit 430 routes any communication received from one of the two components to the other one.

In another example, the graphics subsystem 405 of the processing subsystem 400 is allowed to communicate with the graphics subsystem 425 of the processing subsystem 420 by forming a data path 500. Any communication through this path is routed by the processor units 410 and 430.

It is to be noted that the routing may be completely transparent to the software. That is, the software just needs to provide the addresses of the receiving component so that from a software perspective, each processor unit 410, 430, 450 can communicate with any other component directly. There is no difference with respect to whether a component communicates with another component of the same processing subsystem, or with a component of a foreign processing subsystem.

That is, each processor unit of each processing subsystem can select one of its internal or external links (e.g., Link0, Link1, Link2 or Link3) to send data in response to receiving an address of the target component from a software function. Further, each processor unit can route data from one link to another link dependent on the address of the target component.

This functionality allows to flexibly apply any parallel processing mechanism simply by using accordingly adapted software. There is then no need to re-configure the hardware. Thus, the parallelization method to be used is not hardwired into the system, but is just implemented by means of software. Consequently, various parallelization mechanisms can be used on the same hardware platform without requiring any hardware modifications.

It is to be noted that the software just provides the target addresses, and the routing is done by the underlying link hardware. The software does not need to be responsible for the routing, nor is the routing visible to the components.

In a further embodiment, the performance can still be increased by selecting a software implemented parallelization mechanism which minimizes the communication between the processing subsystems, since this reduces access latencies.

The following description provides some examples of how good use can be made from the graphics subsystems 405, 425, 445. While not limited to these examples, embodiments will be discussed (i) where each graphics subsystem is directly connected to a physical monitor device, (ii) where just one graphics subsystem is connected to a monitor but the graphics workload is split across all graphics subsystems, and (iii) where multiple monitor devices are used in an SMP-like arrangement. In the latter case, the processor units share the workload of a performance intensive operation regardless of whether the operation is graphics related or not.

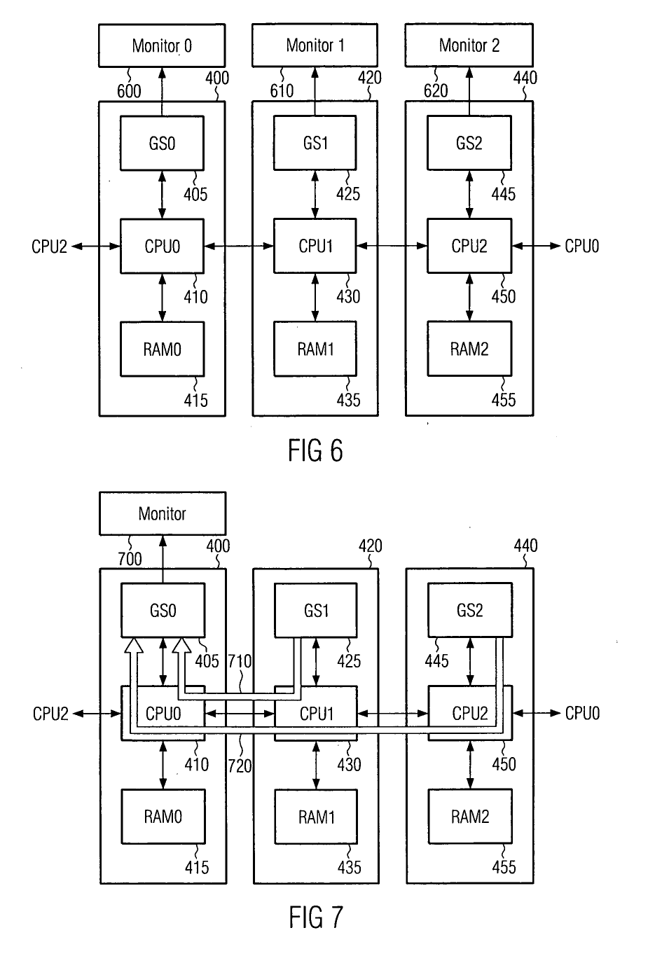

Taking first the multiple monitor embodiment, FIG. 6 shows a multi-processor computing device that is connected to three monitor devices 600, 610, 620. Each graphics subsystem 405, 425, 445 of each processing subsystem 400, 420, 440 is directly connected to one of the monitors. In the present embodiment, each monitor is intended to display a different image.

The arrangement of FIG. 6 may have various applications such as simulation tasks (like flight simulation), games and cave systems. It is noted that other applications may be used in further embodiments.

In the embodiment of FIG. 6, each processor unit 410, 430, 450 pre-processes the data and then sends data and/or commands to its private graphics subsystem 405, 425, 445, i.e., the graphics subsystem of the same processing subsystem. The graphics subsystem then renders the image and displays it on the connected monitor 600, 610, 620.

In other words, taking the example of having multiple viewports as shown in FIG. 6, each viewport is displayed on a separate monitor. Each processor unit pre-processes the data for its corresponding viewport (e.g., culling). The resulting data and commands are sent to the private graphics subsystem which renders the viewport and displays it on the attached monitor. All viewport processing may happen completely in parallel. That is, there may be no communication between the processing subsystems 400, 420, 440 since all communication takes place between the processor units 410, 430, 450 and the respective graphics subsystems 405, 425, 445 of the same processing subsystem 400, 420, 440. In each processing subsystem, the used internal link is not requested by any other system component so that the communication between the processor units and the respective graphics subsystems can use the full uninterrupted bandwidth. This increases system parallism and performance to the maximum possible.

Turning now to the single monitor embodiment mentioned above, FIG. 7 shows an example system where only one monitor device 700 is connected to just one of the processing subsystems. In this embodiment, one image is generated for one monitor, using all system resources. This means that all processor units 410, 430, 450 and graphics subsystems 405, 425, 445 of all processing subsystems 400, 420, 440 are used to generate the single monitor image.

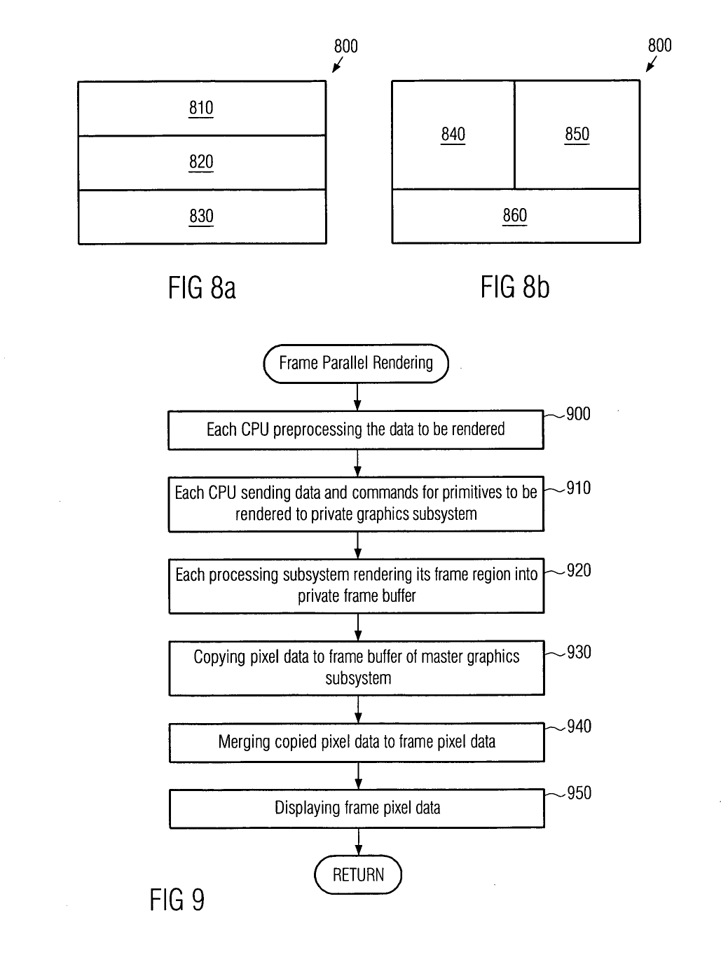

To achieve this, the present embodiment splits the amount of processing work per frame into multiple workloads which are then distributed to all processing subsystems. The frame may be tiled in many different ways, and the processing may be interleaved. Examples of how a frame may be split are given in FIGS. 8a and 8b.

In the embodiment of FIG. 8a, the frame 800 is horizontally split into three equal-sized frame regions 810, 820, 830. FIG. 8b shows an example where the frame is split into three different rectangular frame regions 840, 850, 860, noting that even in the arrangement of FIG. 8b, the frame regions are of the same superficial extent. However, frame regions 840, 850 have both the horizontal and vertical dimensions chosen to be less than the respective dimensions of the entire frame 800.

It is to be noted that in other embodiments, the frame regions may be arranged in any other configuration, and there is then no need for the frame regions to be of the same size or superficial extent.

Referring, however, back to the arrangements of FIGS. 8a and 8b, each processing subsystem 400, 420, 440 takes over a third of the processing load to render a frame. This reduces the overall system processing time. The results then have to be combined to generate the final image of the total frame. That is, each processing subsystem has one of the frame regions associated, performs the rendering, and then copies the result to the processing subsystem to which the monitor device is connected.

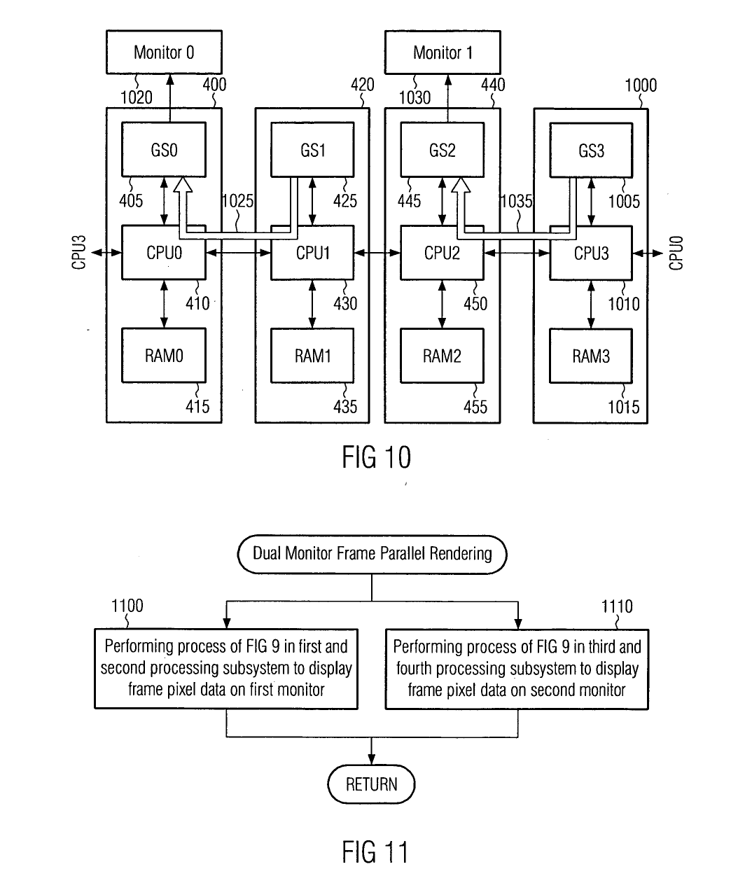

Referring to the flow chart of FIG. 9, this process will now be described in more detail. In step 900, each processor unit 410, 430, 450 pre-processes the data and decides which primitives are to be rendered in its associated frame region. Each processor unit 410, 430, 450 then sends the data and/or commands for the primitives which belong to the individual frame regions to its private graphics subsystem 405, 425, 445 (step 910). That is, there is only internal communication occurring in this step. Since the used link is not required by any other system component, the full uninterrupted bandwidth of the link can be used.

Once all processing subsystems have rendered their frame region into their private frame buffer (which may be located in the graphics memory 320) in step 920, the results are copied to the master graphics subsystem 405 via data paths 710, 720 in step 930. The copied pixel data are then merged into the frame buffer of the graphics subsystem 405 (step 940) so that the frame pixel data can be displayed on the monitor 700.

While the copying of step 930 is shown in FIG. 7 to use data paths 710, 720, it is to be noted that copying may be done in different ways in further embodiments. For instance, while it is each respective processor unit which may perform the copying, it may also be done using a transfer controller which is built in the processor units, or the graphics subsystems may even be able to perform the copying on their own.

That is, embodiments may exist where the graphics subsystems have a direct link between them to merge the data. Alternatively, the rendered frame region data can be combined at the monitor output.

As mentioned above, the discussed multi-monitor or single-monitor arrangements are merely non-limiting embodiments. In general, the parallel-processing approach of the embodiments is generic in the sense that it is not restricted to the use of graphics. In other words, embodiments exist that may run standard SMP applications. Taking for instance the hardware arrangement of FIG. 6, a standard multi-processing application may be used unchanged on the system, and the parallel graphics subsystems allow to support fast graphics updates on multiple monitor systems. Taking for instance the example of an application which requires high computational performance and fast display of the results, all processor units process certain data in parallel to achieve a high degree of parallism and performance. Once the data is processed, the displays need to be updated. This may be done in an embodiment where each processor unit communicates just with its private graphics subsystem. In other embodiments, system-wide communication may be used as well. Examples of such applications may be visualization systems, video editing, DCC (Digital Content Creation) applications or the like.

As mentioned above, the number of processing subsystems in the multi-processor computing devices of the embodiments is not limited to three. Further, a processing subsystem may contain more than one graphics subsystem for certain requirements. Respective embodiments will now be discussed with reference to FIGS. 10 to 12.

Referring first to FIG. 10, a dual monitor system with four processing subsystems 400, 420, 440, 1000 is shown. Only two of the processing subsystems are connected to an individual monitor device 1020, 1030. That is, one viewport is supported for each monitor, and the unconnected processing subsystems may use the frame region approach to parallize the work per viewport onto processing subsystems. In the embodiment of FIG. 10, processing subsystems 400, 420 do the frame rendering for monitor 1020 while processing subsystems 440, 1000 work for monitor 1030. It is to be noted that both viewports may be handled simultaneously.

Referring to the flow chart of FIG. 11, it is apparent that the present embodiment combine the methodology of the embodiments shown in FIGS. 6 and 7. That is, each pair of processing subsystems substantially performs the process shown in FIG. 9 to display the frame pixel data on the respective monitor device, using respective data paths 1025, 1035. That is, the processor units 410, 430 pre-process the data for the first viewport and decide which primitives will be rendered in the respective frame region. The same is simultaneously done by processor units 450, 1010 with respect to the second viewport.

The data and commands for the primitives of the respective frame region are then sent from each individual processor unit to the respective private graphics subsystem using the full uninterrupted bandwidth of the respective link. Once all processing subsystems have rendered their frame region into their private frame buffers, the results are merged into the frame buffers of the graphics subsystems 405, 445, respectively. Then the two different frames are simultaneously displayed, one at the monitor 1020 and the other at monitor 1030.

It is noted that in particular the copying of the pixel data for each viewport can occur in parallel.

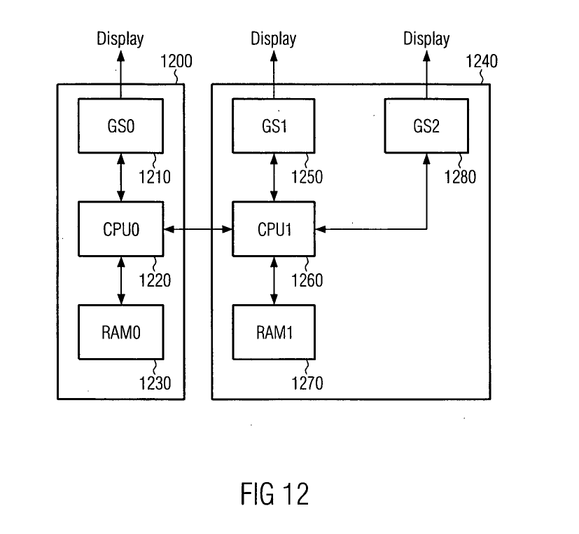

Referring now to FIG. 12, a dual processor system is shown having three display ports. In the embodiment of FIG. 12, the processing subsystem 1240 has two graphics subsystems 1250, 1280 which are each connected to the processor unit 1260 by their own private links which can be independently and transparently addressed as discussed above.

As apparent from the foregoing description of the various embodiments, a highly parallel system architecture is shown which allows for highly efficient parallel processing of regular computational tasks as well as graphics processing. All parallelization is done by software and no hardwired parallelization mechanism is imposed. This makes the system very flexible and adaptable to the needs of the software.

Further, the use of multiple parallel links leads to the availability of a huge overall system bandwidth and therefore makes highly concurrent operations possible. Further, the usage of processing subsystems makes the system very scalable in regard to the number of processing subsystems used in the interconnection topology. The topology is transparent to the software.

It is further to be noted that the use of completely software-implemented parallel processing mechanisms also allows to combine different parallelization mechanisms into one system. Further, it is to be noted that in any of the above embodiments, the processors may comprise multiple processor cores.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention. In addition, those areas in which it is believed that those of ordinary skill in the art are familiar, have not been described herein in order to not unnecessarily obscure the invention described herein. Accordingly, it is to be understood that the invention is not to be limited by the specific illustrative embodiments, but only by the scope of the appended claims.

What is claimed is:

1. A multi-processor computing device comprising:
at least two processing subsystems each comprising a processor unit and at least one further component,
wherein in each one of said at least two processing subsystems, the processor unit is connected to said at least one further component via at least one first link,
wherein in each one of said at least two processing subsystems, the processor unit is further adapted to be connected to at least one processor unit of another one of said at least two processing subsystems via at least one second link,
wherein said at least one first link and said at least one second link are physically decoupled, and
wherein said at least two processing subsystems are capable of simultaneously sending data over said at least one first link and said at least one second link.

2. The multi-processor computing device of claim 1, wherein each processor unit of said at least two processing subsystems is adapted to select one of said first and second links to send data, in response to receiving an address of a target component within anyone of said at least two processing subsystems, said target component being the intended recipient of said data.

3. The multi-processor computing device of claim 2, wherein the processor units of said at least two processing subsystems are adapted to receive said address of said target component from a software function.

4. The multi-processor computing device of claim 2, wherein each processor unit of said at least two processing subsystems is capable of routing data from one of said first and second links to another one of said first and second links dependent on said address of said target component.

5. The multi-processor computing device of claim 1, wherein said at least one further component is a graphics subsystem adapted to perform graphics operations.

6. The multi-processor computing device of claim 5, wherein said graphics subsystem is a graphics adapter card.

7. The multi-processor computing device of claim 6, wherein said graphics subsystem comprises a PCI (Peripheral Component Interface) Express interface unit.

8. The multi-processor computing device of claim 5, wherein said graphics subsystem is an integrated circuit chip directly coupled to the respective processor unit via said at least one first link.

9. The multi-processor computing device of claim 5, wherein said graphics subsystem is a subunit of the respective processor unit, integrated on the same chip as the respective processor unit.

10. The multi-processor computing device of claim 5, wherein said graphics subsystem is a graphics interface unit capable of interfacing to an external graphics system.

11. The multi-processor computing device of claim 5, wherein said graphics subsystem comprises a graphics processor adapted to perform graphics processing.

12. The multi-processor computing device of claim 11, wherein said graphics processor is adapted to be connected to a display unit.

13. The multi-processor computing device of claim 5, wherein said graphics subsystem comprises a graphics memory.

14. The multi-processor computing device of claim 5, wherein the processor units of said at least two processing subsystems are adapted to form a data path from a graphics subsystem of a first one of said processing subsystems to a graphics subsystem of a second one of said processing subsystems, said data path comprising a first link between the graphics subsystem of the first processing subsystem and the processor unit of the first processing subsystem, a second link between the processor unit of the first processing subsystem and the processor unit of the second processing subsystem, and another first link between the processor unit of the second processing subsystem and the graphics subsystem of the second processing subsystem.

15. The multi-processor computing device of claim 5, wherein the processor units of said at least two processing subsystems are adapted to form a data path from the processor unit of a first one of said processing subsystems to a graphics subsystem of a second one of said processing subsystems, said data path comprising a second link between the processor unit of the first processing subsystem and the processor unit of the second processing subsystem, and a first link between the processor unit of the second processing subsystem and a graphics subsystem of the second processing subsystem.

16. The multi-processor computing device of claim 5, wherein the graphics subsystems of each of said at least two processing subsystems are capable of being connected to an individual display device, and each graphics subsystem is adapted to perform graphics operations solely for the display device to which it is connected.

17. The multi-processor computing device of claim 5, wherein a graphics subsystem of one of said at least two processing subsystems is adapted to perform graphics operations for a display device connected to a graphics subsystem of another one of said at least two processing subsystems.

18. The multi-processor computing device of claim 17, wherein said graphics subsystem of said one processing subsystem is adapted to perform all of the graphics operations necessary for said display device connected to said graphics subsystem of said other processing subsystem.

19. The multi-processor computing device of claim 17, wherein said graphics subsystem of said one processing subsystem is adapted to perform graphics operations necessary to display a frame region at said display device connected to said graphics subsystem of said other processing subsystem, while said graphics subsystem of said other processing subsystem is adapted to perform graphics operations necessary to display another frame region at said display device.

20. The multi-processor computing device of claim 19, wherein a graphics subsystem of a third processing subsystem is adapted to perform graphics operations necessary to display a third frame region at said display device connected to said graphics subsystem of said other processing subsystem.

21. The multi-processor computing device of claim 20, wherein the frame regions are of the same superficial extent.

22. The multi-processor computing device of claim 20, wherein the frame regions have the same dimensions.

23. The multi-processor computing device of claim 20, wherein the frame regions are arranged to horizontally split the entire frame.

24. The multi-processor computing device of claim 20, wherein at least one of said frame regions has a horizontal dimension less than the entire frame, and a vertical dimension less than the entire frame.

25. The multi-processor computing device of claim 19, wherein the processor units of said one and said other processing subsystems are adapted to preprocess data to be displayed to decide which primitives are to be rendered in the respective frame region.

26. The multi-processor computing device of claim 25, wherein the processor units of said one and said other processing subsystems are adapted to send data and/or commands to the graphics subsystem connected to the respective processor unit via a first link.

27. The multi-processor computing device of claim 26, wherein the graphics subsystems are adapted to render the respective frame regions in response to receiving said data and/or commands.

28. The multi-processor computing device of claim 27, wherein the processing subsystems are adapted to copy rendered pixel data from the graphics subsystem of said one processing subsystem to the graphics subsystem of said other processing subsystem.

29. The multi-processor computing device of claim 28, wherein the processing subsystems are adapted to copy the rendered pixel data via the processor units of the processing subsystems.

30. The multi-processor computing device of claim 28, wherein the processing subsystems are adapted to copy the rendered pixel data via a dedicated link between the the graphics subsystems of the processing subsystems.

31. The multi-processor computing device of claim 28, wherein the graphics subsystem of said other processing subsystem is adapted to merge the copied pixel data with its own rendered pixel data to display the merged pixel data at said display device.

32. The multi-processor computing device of claim 27, wherein the processing subsystems are adapted to merge pixel data rendered by the graphics subsystem of said one processing subsystem and pixel data rendered by the graphics subsystem of said other processing subsystem at a line synch output to said display device.

33. The multi-processor computing device of claim 5, wherein said at least two processing subsystems comprises a first and a second processing subsystem having their respective graphics subsystems connected to an individual display device, and a third and a fourth processing subsystem not having their respective graphics subsystems connected to a display device, wherein said third and fourth processing subsystems are adapted to perform graphics operations for the display devices at the graphics subsystems of the first and second processing subsystems, respectively.

34. The multi-processor computing device of claim 33, adapted to simultaneously perform the operation of the first and third processing subsystems, and the operation of the second and fourth processing subsystems.

35. The multi-processor computing device of claim 5, wherein at least one of said processing subsystems comprises two or more graphics subsystems separately and independently connected to the processor unit of the processing subsystem.

36. The multi-processor computing device of claim 1, wherein said at least one further component is a memory unit.

37. The multi-processor computing device of claim 1, wherein in each one of said at least two processing subsystems, the processor unit is connected to two components of the respective processing subsystem via two separate first links, and wherein in each one of said at least two processing subsystems, the processor unit is further adapted to be connected to two processor units of other processing subsystems via two separate second links.

38. The multi-processor computing device of claim 37, wherein said two component are a graphics subsystem adapted to perform graphics processing, and a memory unit.

39. The multi-processor computing device of claim 1, capable of running SMP (Symmetric Multi-Processing) applications.

40. The multi-processor computing device of claim 1, further comprising at least one interface unit to interface to at least one system component other than said at least two processing subsystems, wherein at least one of said at least two processing subsystems is adapted to be connected to said at least one interface unit.

41. The multi-processor computing device of claim 40, wherein said at least one interface unit is a system bridge.

42. The multi-processor computing device of claim 1, wherein said first and second links are HyperTransport™ compliant links.

43. A processing subsystem for use in a multi-processor computing device, the processing subsystem comprising:
a processor unit; and
at least one further component,
wherein the processor unit is connected to said at least one further component via at least one first link,
wherein the processor unit is further adapted to be connected to at least one processor unit of another processing subsystem via at least one second link,
wherein said at least one first link and said at least one second link are physically decoupled, and
wherein said processing subsystem is capable of simultaneously sending data over said at least one first link and said at least one second link.

44. A multi-processor computing method comprising:
operating a first and a second processing subsystem of a multi-processor computing device, said first and second processing subsystems each comprising a processor unit and at least one further component,
wherein operating said first and second processing subsystems comprises:
simultaneously sending data over at least one first link between the processor unit and a respective further component of one of said first and second processing subsystems, and at least one second link between the processor units of said first and second processing subsystems, said at least one first link and said at least one second link being physically decoupled.

45. A computer-readable storage medium storing instructions that, when executed on a multi-processor computing device having at least two processing subsystems each comprising a processor unit and at least one further component, cause said multi-processor computing device to simultaneously send data over at least one first link between the processor unit and a respective further component of one of said processing subsystems, and at least one second link between the processor units of said processing subsystems, said at least one first link and said at least one second link being physically decoupled.
